(19) United States
(12) Patent Application Publication
(10) Pub. No.: US 2003/0072942 A1
(43) Pub. Date: Apr. 17, 2003

(54) Combinative carbon material

(75) Inventors: Chien-Liang Hwang, Shin-Juang (TW); Jack Ting, Hsinchu (TW); Jih-Shun Chiang, Hsinchu (TW)

Correspondence Address: SUGHRUE, MION, ZINN,, MACPEAK & SEAS, PLLC, 2100 Pennsylvania Avenue, N.W., Washington, DC, 20037-3213, US

(73) Assignee: INDUSTRIAL TECHNOLOGY RESEARCH INSTITUTE

(21) Appl. No.: 10/176,522

(22) Filed: Jun. 24, 2002

(30) Foreign Application Priority Data
Oct. 17, 2001 (TW) 90125666

(51) Int. Cl. B32B 9/00

(52) U.S. Cl. 428/408

(57) ABSTRACT

A combinative carbon material is presented. A large-sized carbon material serving as a support combines with a nano-sized fibrous carbon material, which grows on the support. In addition to the support, a catalyst system includes an active nanocatalyst and an optional co-catalyst. The catalyst system is then reacted with a carbon source at an elevated temperature to form a combinative carbon material.

### BACKGROUND OF THE INVENTION

1. Field of the Invention

The present invention relates to a combinative carbon material and its preparation. More particularly, it relates to grafting a nanofibrous carbon material on a larger support of carbon material to form a superior combinative carbon material.

2. Description of the Related Arts

The nano-fibrous carbon materials with diameters of 1-200 nm include, for example, carbon nanofibers, single-walled carbon nanotubes (SWNTs), multi-walled carbon nanotubes (MWNTs) and others. The preparations of these materials used today are mainly arc discharging, laser vaporization, thermal chemical vapor deposition (hereafter CVD). Among all these, arc discharging (Journet et al., Nature 388:756(1997), and Bethune et al., Nature 363:605(1993)) and laser vaporization (Smally et al., Science 273:483(1996)) have difficulties in controlling length and diameters of products, low production rate, and excess production of amorphous carbon which requires further purification and causes problems in future engineering scale-up steps.

Thermal CVD for preparing nanofibrous carbon material is known to use porous silica (Li et al., Science 274:1701(1996)), zeolite, alumina (Willems et al., Chemical Physics Letters 317:71(2000)) or magnesium oxide (Colomer et al., Chemical Physics Letters 317:83(2000)) as a support, synthesizing a catalyst precursor by impregnation, and then forming a supported metal catalyst through reduction with H₂ at high temperatures. The main reason for choosing these support is that the supports are stable inorganic oxides. Therefore, the possibility for the support to react with the active metal of the catalyst is quite low. Thus, inactivation of the metal by the support, creating a failure to catalyze the synthesis of nanotubes, is avoided. After the reaction, the products are purified by acid in order to remove the support and catalyst.

Deposition precipitation is applied mainly in the synthesis of hydrogenation catalyst of Pd, Pt on carbon support (U.S. Pat. No. 5,068,161). This preparation is able to regulate the size of the metal particles to obtain higher degrees of dispersion. It is also possible to chemically reduce the catalyst to a metal state and then avoid metal aggregation in reduction at high temperatures. Deposition precipitation is superior to impregnation because metal elements have lower activity in a metal state than in an ion state, and this decreases the reaction between active metals and supports, which inactivates the metals. However, one disadvantage is that the catalyst is rendered inactive by carbon coating when the reaction is performed at a temperature over 550° C.

Nanofibrous carbon material has unusual properties, such as low density, high strength, high toughness, flexibility, high surface area and curvature, high thermal conductivity and electric conductivity, etc. Therefore, it is valuable in applications, including composite materials, microelectronic devices, flat panel displays, wireless communications, fuel cells, lithium batteries and so on.

Nevertheless, most preparations meet a difficulty when it comes to the process of mixing nanofibrous carbon material with other materials, such as large-sized graphite or mesophase carbon micro-beads (MCMB) in practice. Unfortunately, fibrous carbon material with nanotubes forms small masses within its own structure. Thus, one is unable to obtain uniform mixing of nanofibrous carbon material with other large-sized materials. The non-uniform mixing reduces the performance of the products and wastes materials. Therefore, there is still a need for a solution to the mixing problem in the application of nanofibrous carbon material, a primary object of the present invention.

### SUMMARY OF THE INVENTION

The present invention provides a method for preparing combinative carbon material, which comprises the steps of implanting an active nanocatalyst onto a carbon support to form a catalyst system, and performing carbon deposition by introducing a carbon source to the catalyst system such that a nanofibrous carbon material is grafted onto the carbon support. Chemical grafting allows implantation of a nanofibrous carbon material around an independent large-sized carbon and results in a uniform carbon mixture without further mixing.

Another aspect of the present invention provides a combinative carbon material which combines two carbon materials with different sizes, structures and properties by chemical reaction and comprises a carbon support and a nanofibrous carbon material, wherein the nanofibrous carbon material is chemically grafted on the carbon support.

The present invention is different from the known thermal CVD for the synthesis of nanotubes. The method for preparing combinative carbon material in this invention eliminates the necessity to remove the support. On the contrary, the support itself is a large-sized carbon material; it is therefore effective to distribute the combinative carbon material into other materials.

### BRIEF DESCRIPTION OF THE DRAWINGS

The present invention will be more fully understood and further advantages will become apparent when reference is made to the following description of the invention and the accompanying drawings in which:

FIG. 1 is a schematic diagram showing combinative carbon materials in the present invention; (a) a sheet-shaped graphite combined with nanofibrous carbon materials; (b) a spherical mesophase carbon micro-beads (MCMB) combined with nanofibrous carbon materials; and (c) a cylindrical large-sized carbon fiber combined with nanofibrous carbon materials.

FIG. 2 is a schematic diagram showing the process for preparing a combinative carbon material wherein 10, 20 and 30 indicate a carbon support, a nanofibrous carbon material and a nanocatalyst, respectively.

FIG. 3(a) to 3(c) are SEM photographs showing the mesophase carbon micro-beads combined with nanofibrous carbon materials synthesized in the present invention.

### DETAILED DESCRIPTION OF THE INVENTION

Unless otherwise defined, all technical and scientific terms used herein have the same meaning as commonly understood by one of ordinary skill in the art to which this invention belongs. All publication and references mentioned are incorporated by reference in their entirety. In case of conflict, the present specification, including definitions, will control.

As used herein, the term “nanofibrous carbon material” refers to a fiber carbon material with a diameter of 1-200 nm, including solid and hollow structures, such as nanofiber, single-walled nanotube, or multi-walled nanotube.

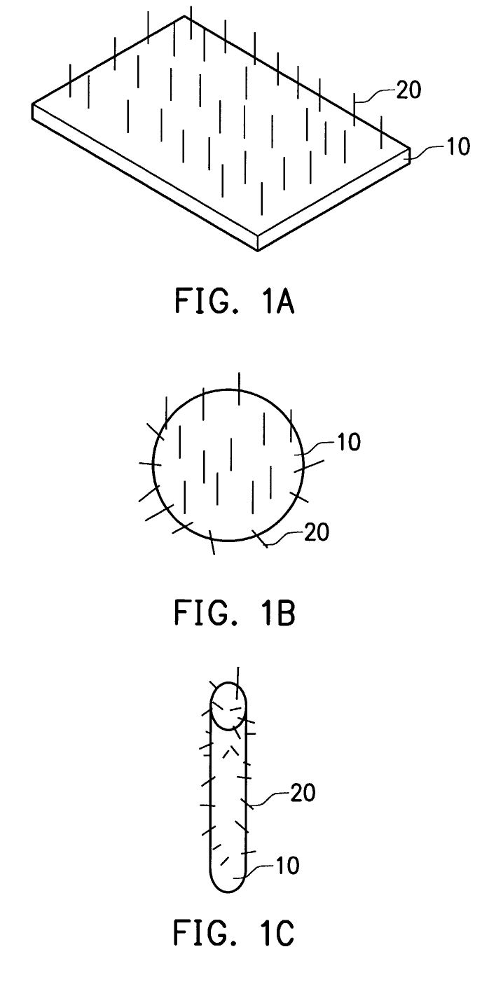

The term “larger-sized carbon material” or “large-sized carbon material” used herein, compared to nanofibrous carbon material, refers to a carbon material generally with a size of 500 nm to 50 g m used as a support in the present invention. The carbon material used as the support in this invention includes, but is not limited to, graphite, active carbon, MCMB or carbon fiber. The shape of the support carbon material is not limited, and can be a sheet, sphere, cylinder or irregular granulation. FIG. 1 is a schematic diagram showing combinative carbon material produced from the carbon support with different shapes.

In the combinative carbon material of the invention, the nanofibrous carbon material is preferably present in an amount ranging from about 5 to 50 parts by weight, more preferably from about 10 to 25 parts by weight, based on 100 parts by weight of the carbon support. An amount thereof less than 5 parts by weight results in failure to sufficiently exhibit the characteristics of the nanofibrous carbon material, whereas that more than 50 parts by weight results in oversized nanofibrous carbon material.

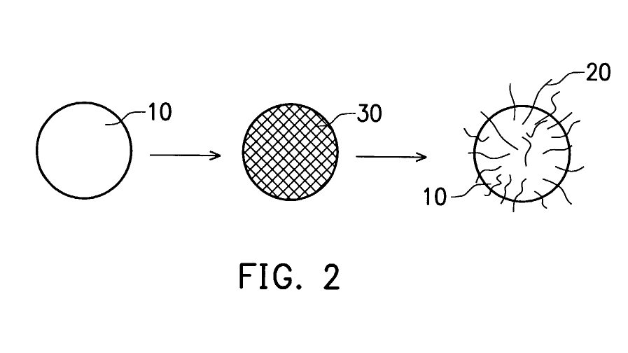

FIG. 2 is a schematic diagram of the process for preparing combinative carbon material. In accordance with the present invention, the active nanocatalyst 30 was first implanted onto the carbon support 10 to form a catalyst system. Unlike the prior art using impregnation, deposition precipitation was used in this invention to immobilize the active nanocatalyst 30 onto carbon support 10 for the purpose of controlling the succeeding growth of nanotubes more effectively.

Deposition precipitation is well known in the art. Generally speaking, this process comprises the steps of: dispersing a support 10 in a solvent, e.g. water or alcohol (for example, ethanol); adding a salt solution of an active nanocatalyst 30 to the solvent to form a reaction mixture; then adding a precipitation agent, e.g. ammonia or NaHCO₃ to the reaction mixture and heating the same; adding a reducing agent, e.g. hydrazine, formaldehyde, or benzaldehyde, to the reaction mixture to reduce the active nanocatalyst; filtrating and drying in order to obtain large-sized carbon support with active catalyst, thus forming a catalyst system.

The above solvent is preferably used in an amount ranging from about 2000 to 10000 parts by weight, more preferably from about 4000 to 6000 parts by weight, based on 100 parts by weight of the carbon support. An amount thereof less than 2000 parts by weight results in poor dispersion of the carbon material, whereas that more than 10000 parts by weight results in difficulty in subsequent processing.

The content of the active nanocatalyst salt in the salt solution is preferably from about 5 to 20 parts by weight, more preferably from about 5 to 10 parts by weight, based on 100 parts by weight of the salt solution. A content thereof less than 5 parts by weight results in insufficient catalyst, whereas that more than 20 parts by weight results in agglomeration of catalyst.

The precipitation agent is preferably added in an amount ranging from about 100 to 200 parts by weight, more preferably from about 100 to 150 parts by weight, based on 100 parts by weight of the active nanocatalyst. An amount thereof less than 100 parts by weight leads to insufficient precipitation.

The reducing agent is preferably added in an amount ranging from about 100 to 200 parts by weight, more preferably from about 100 to 150 parts by weight, based on 100 parts by weight of the active nanocatalyst. An amount thereof less than 100 parts by weight leads to incompleted reduction, whereas that more than 150 parts by weight is a waste. In the above mentioned process, it is necessary to modify the support surface with sodium hydroxide or ammonium in case the active nanocatalyst cannot be deposited onto the support due to the influence of features of the support surface.

The active nanocatalyst used in the present invention includes transition elements and salts. Transition elements include VIIIB elements in the periodic table, for example, but not limited to, Fe, Co, Ni, and so on; the salts include, for example, nitrate, sulfate, or acetate. The active nanocatalyst is preferably used in an amount ranging from about 1 to 20 parts by weight, more preferably from about 5 to 10 parts by weight, based on 100 parts by weight of the carbon support. An amount thereof less than 5 parts by weight results in insufficient growth of nanotubes, whereas that more than 20 parts by weight results in difficulty in dispersing the combinative carbon material due to excess metal.

Furthermore, it is possible to incorporate co-catalysts as needed for modifying the activity and/or selectivity of the catalyst system and controlling the following growth of nanotubes more effectively. The co-catalyst used herein includes, but is not limited to, Wo, Bi, Cd, Cu, V, Mn, Pd, Pt, and so on. It will be recognized by persons skilled in this art that the amount of active nanocatalyst or co-catalyst added in the present invention can be adjusted according to the effect as wished. The co-catalyst is preferably used in an amount ranging from about 0.1 to 2 parts by weight, more preferably from about 0.5 to 1 parts by weight, based on 100 parts by weight of the carbon support.

After forming the catalyst system, carbon deposition is performed to grow a nanofibrous carbon material on the carbon support. Carbon deposition used herein can be, for example, thermal chemical vapor deposition, which is well known in the nano-carbon material field, having a merit of continuing large-scale manufacture. Generally speaking, the process comprises the steps of: dispersing the large-sized carbon material with the active nanocatalyst produced by the above mentioned process into a solvent such as water or alcohol (e.g., ethanol); distributing the carbon material onto the substrate through ultrasound vibration; and placing the substrate into a carbon deposition reactor. The reaction gas used herein includes inert gas (such as He, Ar, N₂), hydrogen (H₂) and carbon source; wherein the carbon source includes, but is not limited to, hydrocarbons (such as C₂H₄, C₂H₂, and others), carbon monoxide (CO) or the carbon support itself. The carbon source is preferably present in an amount ranging from about 500 to 2000 parts by weight, more preferably from about 800 to 1200 parts by weight, based on 100 parts by weight of the catalyst. An amount thereof less than 500 parts by weight results in insufficient growth of nanofibrous, whereas that more than 2000 parts by weight brings undesired amorphous carbon.

The flow rate of the inert gas is preferably from about 50 to 500 sccm (standard cc/min at 1 atm, 0° C.), more preferably from about 100 to 200 sccm. A flow rate thereof less than 50 sccm results in prolonged reaction time, whereas that more than 500 sccm results in poor reactivity. The flow rate of hydrogen is preferably from about 20 to 150 sccm, more preferably from about 50 to 100 sccm. A flow rate thereof less than 20 sccm causes difficulty in keeping metal state, whereas that more than 100 sccm makes the hydrogen concentration undesirably high. The flow rate of the carbon source is preferably from about 10 to 100 sccm, more preferably from about 40 to 60 sccm. A flow rate thereof less than 10 sccm results in poor reactivity, whereas that more than 100 sccm brings undesired amorphous carbon.

The carbon deposition is preferably performed at high temperatures ranging from about 600 to 1000° C., more preferably from about 600 to 800° C. A reaction temperature less than 600° C. results in low deposition rate, whereas that more than 100° C. results in undesired amorphous carbon. The operating pressure of the carbon deposition is preferably from about 0.5 to 20 atmosphere, more preferably from about 1 to 2 atmosphere. The reaction time typically takes from about 1 to 60 minutes, more typically about 10 minutes. If the reaction time is less than 1 minute, a complete reaction cannot be guaranteed. If the reaction time exceeds 60 minutes, on the other hand, the reaction stops due to inactivation of catalyst.

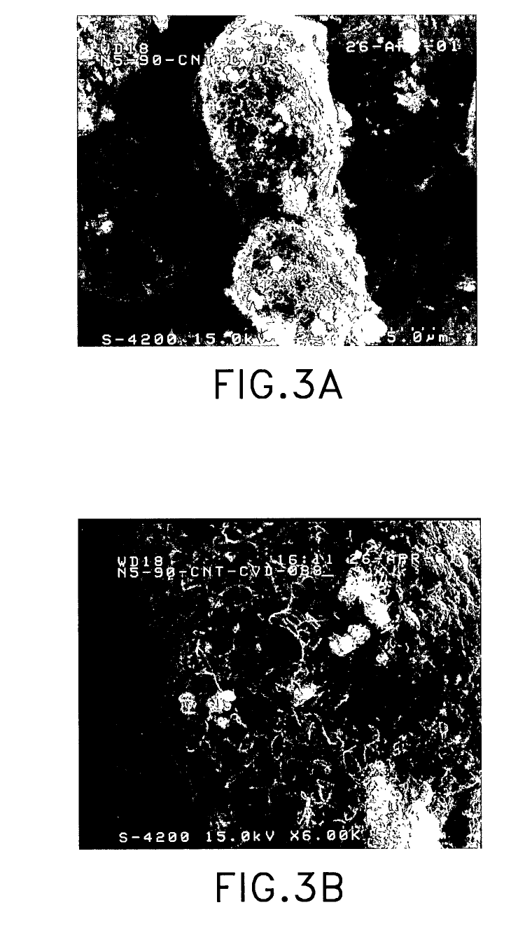

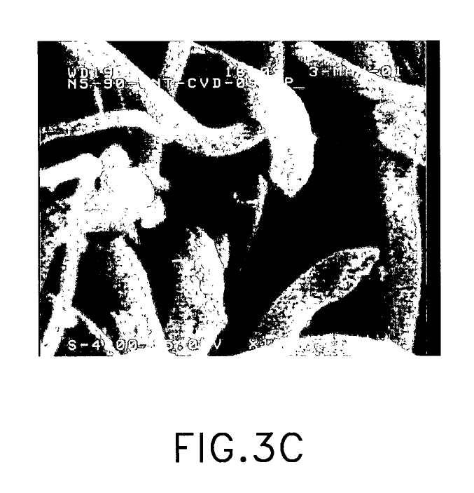

After carbon deposition, the desired nanofibrous carbon material is formed by grafting on the carbon support. The combinative carbon material as shown in FIG. 3 is obtained after boiled with reflux in acidic solution to remove the catalyst.

The combinative carbon material in the present invention eliminates the necessity of removing the support when producing nanofibrous carbon material. Compared to the prior art using inorganic oxide as a support requiring removal after reaction, the method in the present invention is not only economical, but more importantly, the carbon material produced by this method is readily for following applications. In particular, the combinative carbon material of the invention easily achieves uniform mixing with other materials such as mesophase carbon micro-beads.

The combinative carbon material of the invention has a wide range of application, and is outstandingly suitable in electrodes of lithium batteries, fuel cells, and others. In one of the application in this field, for example, lithium battery, there are several problems to be solved. First of all, even if the large-sized carbon material is easily mixed with other materials, the life span of the battery is still shortened. The reason is that the surface graphite of the battery loses the ability to store lithium ions because the distance between graphite layers is enlarged. The enlargement results from moving of lithium ions between graphite layers after multiple charging and recharging. Second, the large-sized carbon material used in the battery industry only utilizes the surface graphite layers and has difficulty utilizing the inner graphite layers. This prevents increase of the effective energy-storage density. Moreover, the effective output of electric power is wasted by the inner electric resistance which cannot be decreased resulting from the low conductivity of the large-sized carbon material. As for these problems, the nanofibrous carbon material in the present invention binds up or wraps arround the large-sized carbon material with similar properties or compatibility in advance in order to inhibit the lengthening of the distance between graphite layers. It is also possible to insert the nanofibrous carbon material into the large-sized carbon material with similar properties or compatibility in advance in order to produce more channels for lithium ions as well as to increase electric conductivity. These two solve the disadvantages of the large-sized carbon material.

Without intending to limit it in any manner, the present invention will be further illustrated by the following examples.

### EXAMPLE

3 g of MCMB was dispersed into 150 ml of water and the solution was stirred for 15 min. 5.5401 g of 28% ammonia was added and the solution was stirred for 5 min. Furthermore, the solution was heated until boiling for 30 min. 3.4 g of 10 wt % nickel nitrate (green in color) aqueous solution was slowly dropped in, and after 5 min, 5.3297 g of 28% ammonia was added. 4 hours of boiling with reflux later, the solution was added with 2.82 g of formaldehyde (reducing agent) and 3.0216 g of 28% ammonia. Finally, the solution was boiled for 30 min, filtered, and dried to obtain the catalyst system (the filtered solution was colorless). 0.2 g of the above treated MCMB (covered with active nanocatalyst) was dispersed into 10 ml of ethanol through ultrasound vibration, and then distributed onto quartz substrate. The substrate was then placed into a CVD reactor and the furnace was heated to 600° C. Inert gas such as Ar (or N₂) was introduced into the reactor in order to remove the air inside. Finally, the gases' flow rates were adjusted (Ar: 150 sccm, H₂: 100 sccm, C₂H₂: 50 sccm) and carbon deposition was performed for 20 min. After reaction, the input of H₂, C₂H₂ and the furnace were turned off and the input of Ar was adjusted to 1500 sccm and the reactor temperature was returned to R.T. MWNTs were thus grafted on MCMB.

In order to remove metal catalyst and to open the ends of MWNTs, the reaction product was soaked in 35-50% nitric acid for 8 hours. The acid solution was boiled with reflux and heated with 140° C. oil bath. The MWNTs were not peeled off from the MCMB by this step of boiling and acid washing. The combinative carbon material in the present invention was thus accomplished.

In FIG. 3(C), the MWNTs formed by the present invention are about 50 nm in outer diameter, as well as most of them still being attached to the support and have open ends (i.e. the active nanocatalyst has been totally removed). In addition, in FIG. 3(B), it is clearly shown in the photograph that the carbon nanotubes formed by the present invention are wound to bind and cover the MCMB support in multiple layers. This condensed structure is helpful for maintaining the function of the carbon nanotubes in future mixing steps. It is also useful for inhibiting enlargement of the distance between graphite layers, creating more moving channels for lithium ions, and increasing electric conductivity in lithium battery application.

While the invention has been particularly shown and described with the reference to the preferred embodiment thereof, it will be understood by those skilled in the art that various changes in form and details may be made without departing from the spirit and scope of the invention.

What is claimed is:

1. A combinative carbon material, comprising a carbon support and a nanofibrous carbon material, wherein the nanofibrous carbon material is chemically grafted on the carbon support.

2. The combinative carbon material as claimed in claim 1, wherein the carbon support is graphite, active carbon, mesophase carbon micro-beads or carbon fiber.

3. The combinative carbon material as claimed in claim 2, wherein the shape of the carbon support is sheet, sphere, cylinder, or irregular granulation.

4. The combinative carbon material as claimed in claim 1, wherein the nanofibrous carbon material is carbon nanofiber, single-walled carbon nanotube, or multi-walled nanotube.

5. A method for preparing a combinative carbon material comprising the steps of:
implanting an active nanocatalyst onto a carbon support to form a catalyst system, and
performing carbon deposition by introducing a carbon source to the catalyst system such that a nanofibrous carbon material is grafted onto the carbon support.

6. The method as claimed in claim 5, wherein the active nanocatalyst comprises transition metals or salts thereof.

7. The method as claimed in claim 6, wherein the transition metals are selected from the VIIIB elements in the periodic table.

8. The method as claimed in claim 6, wherein the salts are nitrate, sulfate, or acetate.

9. The method as claimed in claim 5, further comprising incorporating a co-catalyst into the catalyst system before the carbon deposition step.

10. The method as claimed in claim 9, wherein the co-catalyst is Wo, Bi, Cd, Cu, V, Mn, Pd, or Pt.

11. The method as claimed in claim 5, wherein the carbon support is graphite, active carbon, mesophase carbon micro-beads, or carbon fiber.

12. The method as claimed in claim 11, wherein the shape of the carbon support is sheet, sphere, cylinder, or irregular granulation.

13. The method as claimed in claim 5, wherein the implantation of the active nanocatalyst onto the carbon support is accomplished by deposition precipitation.

14. The method as claimed in claim 13, wherein the deposition precipitation comprises the steps of:
dispersing the carbon support in a solvent,
adding a salt solution of the active nanocatalyst to the solvent to form a reaction mixture,
adding a precipitation agent to the reaction mixture and heating the same, and
adding a reducing agent to the reaction mixture to reduce the active nanocatalyst.

15. The method as claimed in claim 14, wherein the solvent is water or alcohol.

16. The method as claimed in claim 14, wherein the precipitation agent is ammonia or NaHCO₃.

17. The method as claimed in claim 14, wherein the reducing agent is hydrazine, formaldehyde, or benzaldehyde.

18. The method as claimed in claim 5, wherein the carbon source is hydrocarbon, carbon monoxide, or the carbon support itself.

19. The method as claimed in claim 5, wherein the carbon deposition is performed at about 0.5-20 atm.

20. The method as claimed in claim 5, wherein the carbon deposition is performed at about 600-1000° C.

21. The method as claimed in claim 5, wherein the carbon deposition is performed for about 1-60 minutes.

22. The method as claimed in claim 5, wherein the nanofibrous carbon material is carbon nanofiber, single-walled nanotube, or multi-walled carbon nanotube.
